(19) United States
(12) Patent Application Publication
(10) Pub. No.: US 2025/0006199 A1
(43) Pub. Date: Jan. 2, 2025

(54) PHONE RECOGNITION METHOD AND APPARATUS, ELECTRONIC DEVICE AND STORAGE MEDIUM

(71) Applicant: Tencent Technology (Shenzhen) Company Limited, Shenzhen (CN)

(72) Inventors: Binghuai LIN, Shenzhen (CN); Liyuan WANG, Shenzhen (CN)

(73) Assignee: Tencent Technology (Shenzhen) Company Limited, Shenzhen, GD (CN)

(21) Appl. No.: 18/830,160

(22) Filed: Sep. 10, 2024

Related U.S. Application Data
(63) Continuation of application No. PCT/CN2023/129853, filed on Nov. 6, 2023.

(30) Foreign Application Priority Data
Nov. 30, 2022 (CN) 202211525113.4

(51) Int. Cl. G10L 17/02; G10L 17/04; G10L 17/20; G10L 21/0208

(52) U.S. Cl. CPC G10L 17/02; G10L 17/04; G10L 17/20; G10L 21/0208

(57) ABSTRACT

Embodiments of this application relate to phone recognition. A method includes: obtaining a reference voiceprint feature of a target user and to-be-recognized audio; and inputting the to-be-recognized audio into a trained phone recognition model to perform phone recognition, to obtain a phone recognition result, the trained phone recognition model being obtained through training based on first sample audio and second sample audio, the first sample audio being single-user utterance audio, and the second sample audio being multi-user utterance audio. A process of performing the phone recognition includes: extracting an audio feature of the to-be-recognized audio; performing denoising on the audio feature of the to-be-recognized audio based on the reference voiceprint feature, to obtain an acoustic voice feature of the target user; and performing the phone recognition on the acoustic voice feature, to obtain a phone recognition result corresponding to the target user.

### RELATED APPLICATION

This application is a continuation of International Patent Application No. PCT/CN2023/129853, filed Nov. 6, 2023, which claims priority to Chinese Patent Application No. 202211525113.4, filed with the China National Intellectual Property Administration on Nov. 30, 2022 and entitled “PHONE RECOGNITION METHOD AND APPARATUS, ELECTRONIC DEVICE, AND STORAGE MEDIUM”. The contents of International Patent Application No. PCT/CN2023/129853 and Chinese Patent Application No. 202211525113.4 are each incorporated herein by reference in their entirety.

### FIELD OF THE TECHNOLOGY

This application relates to the field of voice processing and machine learning (ML) technologies, and in particular, to a phone recognition method and apparatus, an electronic device, and a storage medium.

### BACKGROUND OF THE DISCLOSURE

A voice recognition technology is a technology of converting lexical content in a human voice into computer-readable input characters. A phone is the smallest phonological unit according to natural characteristics of sound. Currently, voice recognition has a complex processing procedure, mainly including processes such as model training, decoding network construction, and decoding. The processes include a specific phone recognition process.

Currently, a voice command recognition technology is a specific application of an automatic voice recognition technology, which is mainly intended to enable a voice command recognition system to automatically recognize a character string corresponding to a voice by only requiring a user to utter a voice of a command word, without requiring the user to use an input device such as a keyboard, a mouse, or a touch screen. In addition, if the character string is a string corresponding to the command word, a corresponding operation may be triggered. For example, an existing voice wake-up system is a typical system that adopts voice recognition. A user may utter a wake-up command, and the system recognizes whether a voiceprint corresponding to the voice uttered by the user is a specified voiceprint. If the voiceprint corresponding to the voice uttered by the user is the specified voiceprint, the system recognizes whether the voice includes the wake-up command. If the system recognizes that the voice includes the wake-up command, the system wakes up (i.e., starts) a corresponding device. Otherwise, the system does not wake up the corresponding device.

### SUMMARY

Embodiments of this application provide a phone recognition method and apparatus, an electronic device, and a storage medium, to recognize a phone corresponding to a target user by using a more accurate phone recognition model, thereby improving accuracy of phone recognition.

An embodiment of this application provides a phone recognition method. The method includes: obtaining a reference voiceprint feature of a target user and to-be-recognized audio; and inputting the to-be-recognized audio into a trained phone recognition model to perform phone recognition, to obtain a phone recognition result, the trained phone recognition model being trained based on first sample audio and second sample audio, the first sample audio being single-user utterance audio, and the second sample audio being multi-user utterance audio. A process of performing the phone recognition includes: extracting an audio feature of the to-be-recognized audio; performing denoising on the audio feature of the to-be-recognized audio based on the reference voiceprint feature of the target user, to obtain an acoustic voice feature of the target user; and performing the phone recognition on the acoustic voice feature, to obtain a phone recognition result corresponding to the target user.

A second aspect of the embodiments of this application provides a phone recognition apparatus. The apparatus includes: a first obtaining module, configured to obtain a reference voiceprint feature of a target user and to-be-recognized audio; and a phone recognition module, configured to input the to-be-recognized audio into a trained phone recognition model to perform phone recognition, to obtain a phone recognition result, the trained phone recognition model being obtained through training based on first sample audio and second sample audio, the first sample audio being single-user utterance audio, and the second sample audio being multi-user utterance audio. The phone recognition module includes a feature extraction sub-module, a denoising sub-module, and a phone recognition sub-module. The feature extraction sub-module is configured to extract an audio feature of the to-be-recognized audio. The denoising sub-module is configured to perform denoising on the audio feature of the to-be-recognized audio based on the reference voiceprint feature of the target user, to obtain an acoustic voice feature of the target user. The phone recognition sub-module is configured to perform the phone recognition on the acoustic voice feature, to obtain a phone recognition result corresponding to the target user.

An embodiment of this application provides an electronic device, including a processor and a memory. One or more programs are stored in the memory and are configured to be executed by the processor, to implement the above method.

An embodiment of this application provides a computer-readable storage medium, having program code stored therein, the computer code, when executed by a processor, performing the above method.

An embodiment of this application provides a computer program product or a computer program, including computer instructions, the computer instructions being stored in a computer-readable storage medium. A processor of a computer device reads the computer instructions from the computer-readable storage medium, and executes the computer instructions, so that the computer device performs the above method.

### BRIEF DESCRIPTION OF THE DRAWINGS

FIG. 1 is an application scenario diagram of a phone recognition model training method according to an embodiment of this application.

FIG. 2 is a schematic flowchart of a phone recognition method according to an embodiment of this application.

FIG. 3 is a schematic diagram of a display interface for audio recording according to an embodiment of this application.

FIG. 4 is a schematic flowchart of operation S120 in FIG. 2.

FIG. 5 is another schematic flowchart of a phone recognition method according to an embodiment of this application.

FIG. 6 is a schematic structural diagram of a phone recognition model according to an embodiment of this application.

FIG. 7 is a schematic structural diagram of a distillation model of a phone recognition model according to an embodiment of this application.

FIG. 8 is a schematic flowchart of audio capturing and processing according to an embodiment of this application.

FIG. 9 is a schematic diagram of a display interface of a client according to an embodiment of this application.

FIG. 10 is a schematic diagram of another display interface of a client according to an embodiment of this application.

FIG. 11 is a schematic diagram of still another display interface of a client according to an embodiment of this application.

FIG. 12 is a structural block diagram of a phone recognition apparatus according to an embodiment of this application.

FIG. 13 is another block diagram of a phone recognition apparatus according to an embodiment of this application.

FIG. 14 is a structural block diagram of an electronic device configured to perform a method according to an embodiment of this application.

### DESCRIPTION OF EMBODIMENTS

Exemplary implementations are described more comprehensively with reference to drawings. However, the exemplary implementations may be implemented in many forms and are not understood as being limited to examples described herein. Rather, the implementations are provided to make this application more comprehensive and complete, and comprehensively convey the idea of the exemplary implementations to a person skilled in the art.

In addition, the described features, structures, or characteristics may be combined in one or more embodiments in any proper manner. In the following descriptions, a plurality of specific details are provided for comprehensive understanding of the embodiments of this application. However, a person of ordinary skill in the art is to be aware that, the technical solutions in this application may be implemented without one or more of the particular details, or may be implemented by using another method, unit, apparatus, operation, or the like. In other cases, well-known methods, apparatuses, implementations, or operations are not shown or described in detail, to avoid obscuring the aspects of this application.

Block diagrams shown in the drawings are merely functional entities, and do not necessarily correspond to physically independent entities. In other words, the functional entities may be implemented in a form of software, or may be implemented in one or more hardware modules or integrated circuits, or may be implemented in different networks and/or processor apparatuses and/or microcontroller apparatuses.

The flowcharts shown in the drawings are merely exemplary descriptions, and neither necessarily need to include all content and operations, nor necessarily need to be performed in the described order. For example, some operations may be further divided, while some operations may be combined or partially combined. Therefore, an actual execution order may be changed based on an actual situation.

“A plurality of” mentioned herein means two or more.

With the research and progress of the artificial intelligence (AI) technology, the AI technology is researched and applied in many fields, and plays an increasingly important role.

AI is a theory, a method, a technology, and an application system that use a digital computer or a machine controlled by the digital computer to simulate, extend, and expand human intelligence, so as to sense an environment, obtain knowledge, and obtain an optimal result with knowledge. In other words, AI is a comprehensive technology in computer science, which attempts to understand the essence of intelligence and produce a new intelligent machine that may react in a manner similar to human intelligence. A description is provided by using an example in which AI is applied to machine learning (ML).

ML is an interdisciplinary field, involving a plurality of disciplines such as the theory of probability, statistics, the approximation theory, convex analysis, and the theory of algorithm complexity. ML specializes in how a computer simulates or realizes learning behaviors of humans to obtain new knowledge or skills, and reorganizes existing knowledge structures to keep improving performance thereof. ML is the core of AI and a fundamental way to make computers intelligent, which is applied in all fields of AI. In the solutions of this application, phone recognition is mainly performed on to-be-recognized audio through ML.

In some voice wake-up systems, a case that a plurality of users speak simultaneously exists. During recognition on a voice of a target user by a system to perform a wake-up operation, since simultaneous speaking of the plurality of users affects audio of the target user and thereby affects accuracy of a recognition result corresponding to a subsequently recognized voice, the system cannot be woken up, or a wakeup anomaly is caused. Based on the above, the embodiments of this application provide a solution that can accurately recognize a voice of a target user in a case of a plurality of users speak simultaneously.

A phone recognition method provided in an embodiment of this application includes: obtaining a reference voiceprint feature of a target user and to-be-recognized audio; and inputting the to-be-recognized audio into a trained phone recognition model to perform phone recognition, to obtain a phone recognition result, the trained phone recognition model being obtained through training based on first sample audio and second sample audio, the first sample audio being single-user utterance audio, and the second sample audio being multi-user utterance audio. A process of performing the phone recognition includes: extracting an audio feature of the to-be-recognized audio; performing denoising on the audio feature of the to-be-recognized audio based on the reference voiceprint feature of the target user, to obtain an acoustic voice feature of the target user; and performing the phone recognition on the acoustic voice feature of the target user, to obtain a phone recognition result corresponding to the target user.

According to the above method in this embodiment of this application, during the phone recognition on the to-be-recognized audio, the trained phone recognition model obtained through training by using single-user utterance audio and multi-user utterance audio is used, so that the phone recognition result corresponding to a target speaker can be accurately recognized from the multi-user utterance audio, which eliminates voice interference from a person other than the target speaker, thereby effectively improving accuracy of the phone recognition result.

Before detailed description is provided, terms involved in this application are described below.

Phone: It is the smallest phonological unit according to natural characteristics of sound. According to analysis based on articulations in a syllable, one articulation constitutes one phone. The phone is a smallest unit or a smallest voice clip that constitutes a syllable, and is a smallest linear phonological unit defined from a perspective of sound quality.

Sample audio: It may be audio identified with phone information. Different sample audio includes different phone information. In this application, sample audio may specifically include first sample audio and second sample audio. The first sample audio is single-user utterance audio. A label of the first sample audio may include all phones arranged in an articulation order of the user. The second sample audio is multi-user utterance audio (for example, at least two users). A label of the second sample audio may include all phones arranged in an articulation order of at least one user.

Audio feature: It may refer to feature data extracted from audio to characterize data of voice content and identify the voice data. For example, the feature data may be a voice frequency, a volume, emotion, a pitch, and energy, and the like in the audio. All of the data may be referred to as “audio feature data” of the voice data, and is configured for distinguishing between different articulation users corresponding to different audio and distinguishing between different phones corresponding to different audio frames.

Phone recognition model: It is a model obtained through end-to-end training of a large number of annotated sample images by using a deep learning model (for example, a convolutional neural network (CNN) model). A fully trained phone recognition model can perform phone recognition on an audio clip, or perform the phone recognition on audio of a user in multi-user utterance audio.

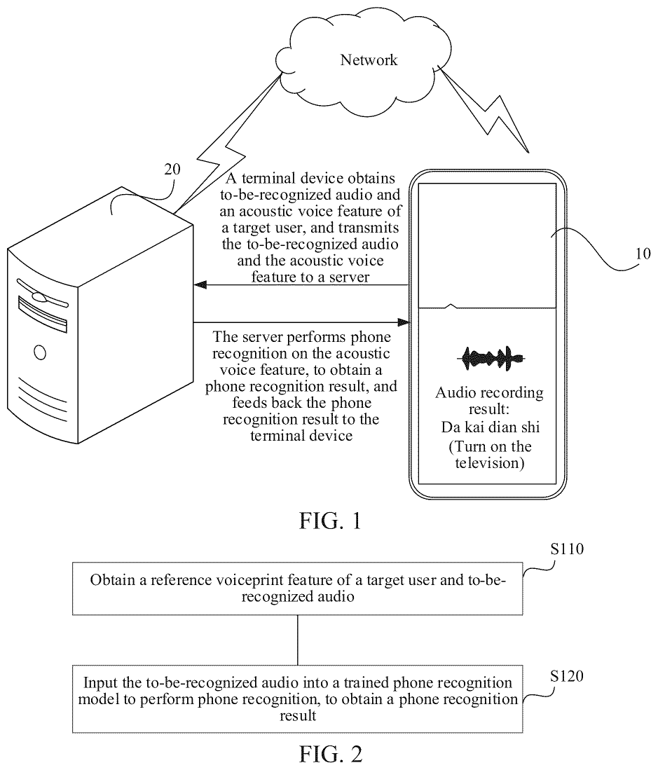

An exemplary application of a device configured to perform the above phone recognition method provided in the embodiments of this application is described below. The phone recognition method provided in the embodiments of this application is applicable to a server in an application environment shown in FIG. 1.

FIG. 1 is a schematic diagram of an application scenario according to some embodiments of this application. As shown in FIG. 1, the application scenario includes a terminal device 10 and a server 20 communicatively connected to the terminal device 10 through a network.

The terminal device 10 may specifically be a mobile phone, a computer, a tablet computer, an on-board terminal, or the like. The terminal device 10 may be equipped with a client configured to display a phone recognition result and record to-be-recognized audio, for example, a content interaction client, an instant messaging client, an education client, a social network client, a shopping client, an audio/video playback client, or a device control client.

The network may be a wide area network, a local area network, or a combination thereof. The terminal device 10 may be a smartphone, a smart television, a tablet computer, a laptop computer, a desktop computer, or the like.

The server 20 may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform.

If a phone recognition model is trained and phone recognition is performed by using the terminal device 10 and the server 20 shown in FIG. 1 to obtain a phone recognition result of to-be-recognized audio, the following operations may be specifically performed. A user may upload first sample audio and second sample audio to the server 20 through the terminal device 10. After obtaining the first sample audio and the second sample audio, the server 20 trains the phone recognition model by using the first sample audio and the second sample audio, to obtain a trained phone recognition model. Subsequently, the user may further obtain the to-be-recognized audio and a reference voiceprint feature of a target user through the terminal device 10 and transmit the to-be-recognized audio and the reference voiceprint feature to the server 20, so that the server 20 performs phone recognition on the to-be-recognized audio by using the trained phone recognition model to obtain a phone recognition result and feeds back the phone recognition result to the terminal device 10. During the phone recognition on the to-be-recognized audio, the server 20 specifically performs the following operations: extracting an audio feature of the to-be-recognized audio; performing denoising on the audio feature of the to-be-recognized audio based on the reference voiceprint feature of the target user, to obtain an acoustic voice feature of the target user; and performing the phone recognition on the acoustic voice feature, to obtain a phone recognition result corresponding to the target user. The server 20 may further transmit the phone recognition result corresponding to the to-be-recognized audio to the terminal device 10, so that the terminal device 10 displays the phone recognition result.

The first sample audio configured for training the phone recognition model is single-user utterance audio, and the second sample audio is multi-user utterance audio. Correspondingly, the trained phone recognition model may be used in a scenario in which a plurality of users speak, i.e., the to-be-recognized audio includes the multi-user utterance audio and the plurality of users include a user corresponding to the reference voiceprint feature of the target user. A phone recognition result corresponding to the reference voiceprint feature of the target user may be recognized by using the above trained phone recognition model. In FIG. 1, the to-be-recognized audio includes a voice “I want to listen to music” of a first user and a voice “Turn on the television” of a second user, and the reference voiceprint feature of the target user is a voiceprint corresponding to the second user. In this case, the phone recognition is performed on the to-be-recognized audio based on the voiceprint corresponding to the second user by using the trained phone recognition model. A result “Da kai dian shi” is obtained. Correspondingly, voice information corresponding to the phone recognition result is “Turn on the television”. As shown in FIG. 1, the terminal device 10 may further display the voice information corresponding to the phone recognition result.

The above operations of the method may be alternatively performed by only the terminal device 10 or only the server 20. In other words, the above operations of the method are merely examples, and are not construed as a limitation on the solution.

The embodiments of this application are described in detail below with reference to the drawings.

FIG. 2 shows a phone recognition method according to an embodiment of this application. The method is applicable to an electronic device. The electronic device may be the above terminal device 10 or server 20. The method includes the following operations:

Operation S110: Obtain a reference voiceprint feature of a target user and to-be-recognized audio.

The obtaining a reference voiceprint feature of a target user may be obtaining a pre-recorded reference voiceprint feature of the target user, or may be obtaining a pre-stored reference voiceprint feature of the target user from the server or a memory, or may be starting recording voice information and performing voiceprint feature extraction on the recorded voice information to obtain the reference voiceprint feature of the target user in response to a voiceprint capturing operation. The above manners of obtaining the reference voiceprint feature of the target user are merely examples, and the reference voiceprint feature of the target user may be obtained in more ways, which is not specifically limited herein.

In some embodiments of this application, the obtaining a reference voiceprint feature of the target user includes: capturing audio of the target user in response to an audio recording operation performed by the target user; and performing voiceprint feature recognition on the audio of the target user, to obtain the reference voiceprint feature of the target user.

To avoid impact on accuracy of the extracted reference voiceprint feature of the target user as a result of noise in the captured audio of the target user, in this implementation, the audio of the target user is captured when a noise intensity is less than a preset value (for example, a second preset value) in the embodiments of this application. The second preset value may be specifically a corresponding decibel value such as 10 decibels, 15 decibels, or 20 decibels in a low noise environment. The audio of the target user in the low noise environment may be obtained in a plurality of manners.

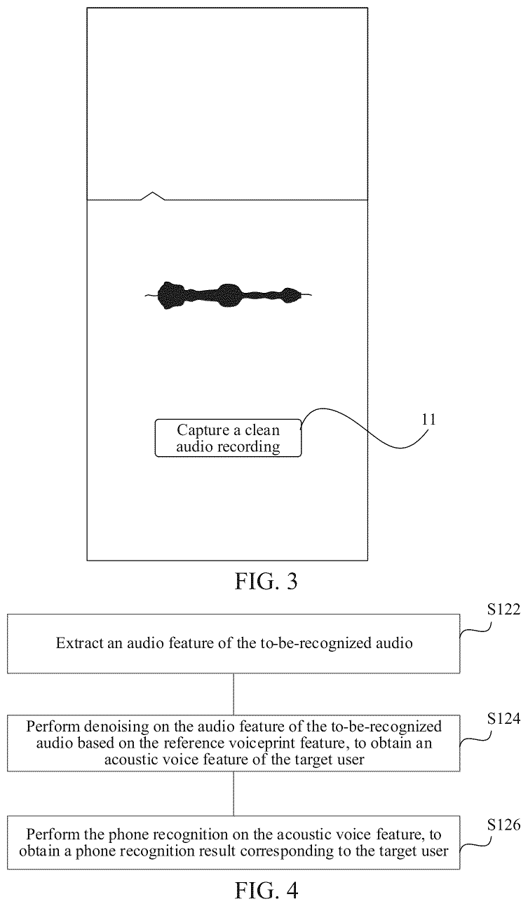

In some embodiments, the terminal device may generate a prompt interface for audio recording in response to a voiceprint feature capturing instruction. As shown in FIG. 3, the prompt interface includes a control 11 that displays prompt information “Capture a clean audio recording”, to prompt the target user to record a voice in the low noise environment. The target user may click/tap the control 11 to indicate that the target user is in the low noise environment and start voice recording. When completing the voice recording, the target user may click/tap the control 11 that displays the prompt information “Capture a clean audio recording” again to complete the recording, and obtain the audio of the target user, so that the reference voiceprint feature of the target user may be obtained based on the audio.

In some other embodiments, to obtain the audio of the target user when the noise intensity is less than the second preset value, environmental noise may be detected before the audio of the target user is recorded. When it is detected that the environmental noise less than the second preset value, the user is prompted to record the audio of the target user.

After the audio of the target user is obtained, the performing voiceprint recognition on the audio of the target user may include encoding the audio of the target user based on an encoder in a pre-trained voiceprint recognition model, to obtain the reference voiceprint feature of the target user. The voiceprint recognition model may be a tuple-based end-to-end model (TE2E model), a generalized end-to-end model (GE2E model), or any model that may be configured to perform voiceprint extraction, which is not specifically limited herein. The voiceprint recognition model may be selected based on an actual need.

One or more reference voiceprint features of the target user may be obtained. When more reference voiceprint features are obtained, the above audio recording process may be performed a plurality of times, to capture reference voiceprint features respectively corresponding to a plurality of target users.

In some implementations, the obtaining the to-be-recognized audio may include obtaining to-be-recognized audio recorded by the electronic device or obtaining pre-recorded to-be-recognized audio, which is set based on an actual need.

The to-be-recognized audio is also referred to as noisy audio, and may be mixed audio simultaneously uttered by a plurality of users recorded by the same microphone. The plurality of users need to include the target user.

Operation S120: Input the to-be-recognized audio into a trained phone recognition model to perform phone recognition, to obtain a phone recognition result.

The trained phone recognition model is obtained through training based on first sample audio and second sample audio, the first sample audio being single-user utterance audio, and the second sample audio being multi-user utterance audio.

The phone recognition model may a CNN model that may be configured to perform phone recognition. Specifically, the CNN model may be an acoustic model based on connection temporal classification (CTC), a recurrent neural network transformer (RNN-T) model, a listen, attend, and spell (LAS) model, or the like.

The phone recognition model may alternatively be a knowledge distillation model. The knowledge distillation model uses a teacher-student mode. A complex and large model is used as the teacher model. A structure of the student model is relatively simple. The student model is trained by using the teacher model. The teacher model with a high learning capability can transfer knowledge learned by the teacher model to the student model with a relatively low learning capability, thereby enhancing a generalization capability of the student model. A complex and cumbersome teacher model with desirable performance is not deployed online, and only a flexible and lightweight student model is deployed online for task prediction.

Specific types of the phone recognition model are merely examples, and more types may exist. The type of the phone recognition model may be set based on an actual need, and is not specifically limited herein.

During the training of the phone recognition model based on the first sample audio and the second sample audio, the first sample audio and the second sample audio may be mixed and inputted into a to-be-trained phone recognition model to train the to-be-trained phone recognition model. A model loss during the training is obtained, and a model parameter is adjusted during the training to minimize the model loss. The training is completed when a parameter adjustment quantity reaches a preset quantity or the model loss reaches a minimum loss, to obtain the trained phone recognition model. As the training of the model progresses, the model loss gradually decreases. Correspondingly, a final trained phone recognition model is more accurate, and the phone recognition performed on the to-be-recognized audio by using the trained phone recognition model is more accurate.

Referring to FIG. 4, a process of performing the phone recognition on the to-be-recognized audio by using the trained phone recognition model includes the following operations:

Operation S122: Extract an audio feature of the to-be-recognized audio.

The extracting an audio feature of the to-be-recognized audio may specifically include extracting the audio feature of the to-be-recognized audio by using a voice encoder of the trained phone recognition model. A type and a structure of the voice encoder specifically depend on a phone recognition model that is used. For example, if the phone recognition model is the RNN-T model, the audio feature of the to-be-recognized audio may be extracted by using a hybrid encoder of the model. If the phone recognition model is the knowledge distillation model, the audio feature of the to-be-recognized audio may be extracted by using an encoder included in the student model of the knowledge distillation model. The above encoders configured to extract the audio feature of the to-be-recognized audio are merely examples. More models and corresponding encoders may be provided to extract the audio feature of the to-be-recognized audio, which are not enumerated herein.

Since the to-be-recognized audio is audio with a duration, and a phone is a smallest unit or voice clip that constitutes audio, the audio is composed of a plurality of phones. Correspondingly, specifically, during the extraction of the audio feature of the to-be-recognized audio, discretization or framing may be performed on the to-be-recognized audio, to obtain a plurality of frames of voices included in the to-be-recognized audio, and audio feature extraction is performed on each frame of voice included in the to-be-recognized audio, to obtain an audio feature corresponding to each frame of voice. The audio feature corresponding to each frame of voice may be subsequently processed, to obtain a phone recognition result corresponding to each frame of voice, thereby obtaining the phone recognition result corresponding to the to-be-recognized audio.

Operation S124: Perform denoising on the audio feature of the to-be-recognized audio based on the reference voiceprint feature, to obtain an acoustic voice feature of the target user.

In some embodiments, the performing the denoising on the audio feature of the to-be-recognized audio based on the reference voiceprint feature of the target user may include performing masking on the audio feature of the to-be-recognized audio based on the reference voiceprint feature of the target user by using the trained phone recognition model, to obtain a masked representation of audio of the target user in the to-be-recognized audio, so as to eliminate interference of audio, in the to-be-recognized audio, of a person other than the target user, thereby achieving a purpose of denoising.

In this manner, a denoising process may specifically include: splicing the reference voiceprint feature and the audio feature of the to-be-recognized audio, to obtain a spliced feature; performing nonlinear transformation on the spliced feature, to obtain a masked representation of the to-be-recognized audio; and multiplying the masked representation of the to-be-recognized audio by the audio feature of the to-be-recognized audio, to obtain the acoustic voice feature of the target user. The nonlinear transformation is performed on the spliced feature, to obtain the masked representation of the to-be-recognized audio, so that masking of an audio feature other than an audio feature of the target user is achieved. In this way, the acoustic voice feature obtained after the masked representation of the to-be-recognized audio is multiplied by the audio feature of the to-be-recognized audio includes only the audio feature of the target user.

In some other embodiments, the performing denoising on the audio feature of the to-be-recognized audio based on the reference voiceprint feature of the target user may alternatively include: encoding the audio feature of the to-be-recognized audio by using a multi-speaker encoder in the trained phone recognition model, to obtain audio features corresponding to different speakers; and searching the audio features corresponding to the different speakers for an audio feature corresponding to the reference voiceprint feature based on the reference voiceprint feature, so as to eliminate the interference of the audio, in the to-be-recognized audio, of a person other than the target user, thereby achieving the denoising. The audio feature corresponding to the reference voiceprint feature is the acoustic voice feature of the target user (or referred to as the audio feature of the target user).

The above denoising manners are merely examples, and more denoising manners may be provided other than those described in this embodiment of this application.

Operation S126: Perform the phone recognition on the acoustic voice feature, to obtain a phone recognition result corresponding to the target user.

The performing the phone recognition on the acoustic voice feature may specifically include performing classification calculation on the acoustic voice feature by using a classifier or a classification function in an output layer of the phone recognition model, to obtain the phone recognition result based on a classification calculation result corresponding to the acoustic voice feature.

Specifically, the classifier or the classification function used in the output layer may be one or more of softmax, SVM, XGBoost, and Logistic Regression. Correspondingly, during the training of the phone recognition model, at least one of a plurality of classifiers or classification algorithms such as softmax, SVM, XGBoost, and Logistic Regression may be respectively trained by using an acoustic voice feature with an annotation. Therefore, the acoustic voice feature may be classified by using the trained classifier or classification algorithm, to obtain the phone recognition result corresponding to the target user.

According to the above phone recognition method in this embodiment of this application, the phone recognition model is trained by using the first sample audio uttered by the single person and the second sample audio uttered by the plurality of persons, so that the phone recognition model can recognize not only a phone corresponding to the single-person utterance audio, but also a phone of audio corresponding to at least one or more speakers when a plurality of persons speak. In this way, subsequently, the phone recognition result corresponding to the target speaker to which the reference voiceprint belongs can be accurately recognized from the audio of the plurality of speakers by using the trained phone recognition model based on the reference voiceprint feature, which eliminates voice interference from a person other than the target speaker, thereby effectively improving accuracy of the phone recognition result.

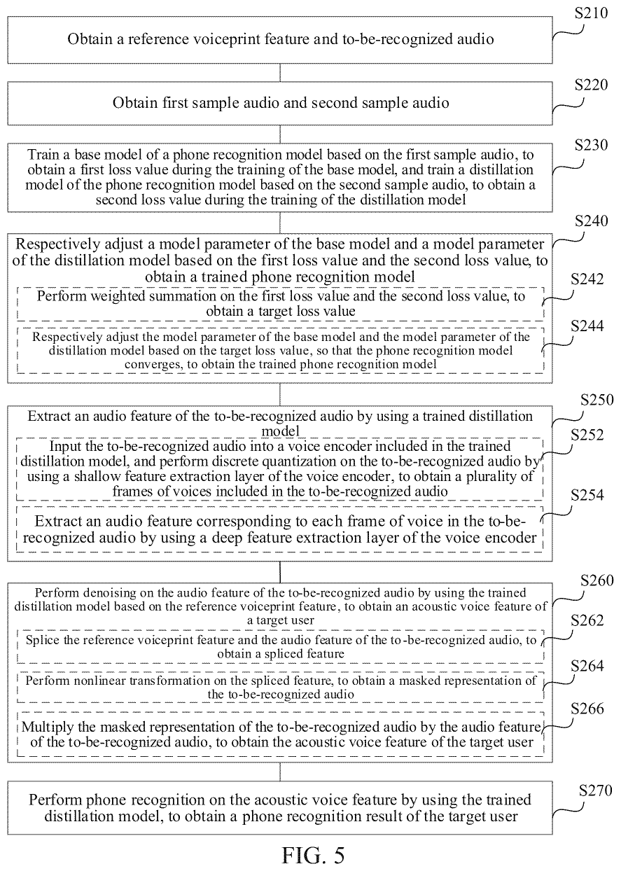

FIG. 5 shows a phone recognition method according to an embodiment of this application. The method is applicable to an electronic device. The electronic device may be the terminal device or the server shown in FIG. 1. The electronic device specifically performs operation S210 to operation S270 during execution of the phone recognition method.

Operation S210: Obtain a reference voiceprint feature and to-be-recognized audio.

Operation S220: Obtain first sample audio and second sample audio.

The obtaining first sample audio may include obtaining recorded audio of a single user, or may include obtaining audio of a single user generated by using an audio generation device, a software program, or the like, or may be extracting audio of one or more single users from certain audio. The above ways of obtaining the first sample audio are merely examples, and other ways are possible. Accordingly, the described ways to obtain the first sample audio is not specifically limited herein.

To improve accuracy of a model trained by using the first sample audio, in this embodiment, it is ensured that little noise interference exists in the first sample audio, thereby avoiding impact on phone recognition of the first sample audio. Correspondingly, the obtaining first sample audio may specifically include obtaining audio recorded by the single user in a low noise environment (an environment with a noise intensity less than a preset value). The preset value may be specifically a first preset value. The first preset value mat be a corresponding decibel value such as 5 decibels, 10 decibels, 15 decibels, or 20 decibels in the low noise environment. The obtaining first sample audio may alternatively include obtaining audio of a single user with noise interference being removed as the first sample audio. Alternatively, the obtaining first sample audio may include intercepting single-user utterance audio from audio with noise interference being removed as the first sample audio.

In some embodiments of this application, the obtaining first sample audio includes: obtaining single-user utterance audio in an environment with a noise intensity less than a first preset value as the first sample audio.

The obtaining second sample audio may include obtaining recorded audio uttered by at least two users, or may be obtaining audio uttered by a plurality of (at least two) users and synthesizing the obtained plurality of pieces of audio to obtain multi-user utterance audio. The above manners of obtaining the second sample audio are merely examples, and more obtaining manners may be provided, which are not described enumerated in this embodiment of this application.

Operation S230: Train a base model of a phone recognition model based on the first sample audio, to obtain a first loss value during the training of the base model, and train a distillation model of the phone recognition model based on the second sample audio, to obtain a second loss value during the training of the distillation model.

A data dimension of the base model is greater than a data dimension of the distillation model.

Specifically, the phone recognition model is a knowledge distillation model, and is composed of a teacher model (the base model) and a student model (the distillation model). Knowledge distillation is a training process of introducing a pre-trained teacher model and inducing the student model by using a soft target outputted by the teacher model. In this way, the student model can learn a predictive behavior of the teacher model, thereby transferring a generalization capability of the teacher model to the student model.

The teacher model (the base model) and the student model (the distillation model) each may be any neural network model such as a CNN model or an RNN model.

In this embodiment of this application, the neural network model respectively included in the teacher model and the student model may be any one of a wav2vec model, a vq-wav2vec model, a wav2vec 2.0 model, a wav2vec 3.0 model, and a discrete BERT model. The above exemplary neural network models respectively included in the teacher model and the student model are merely examples, and other models may be provided, which are not enumerated herein.

The wav2vec model is an unsupervised pre-training voice model. The model includes an encoder network (5 convolution layers) that encodes original audio x into a latent space z, and a context network (9 convolution layers) that converts z into a contextualized representation, with a final feature dimension of 512× frames. A target of the wav2vec model is to predict a future frame at a feature level by using a current frame.

The vq-wav2vec model further introduces a quantization module (vq) based on wav2vec to provide a new model. The model first encodes a given input voice signal X by using an encoder network (the same as the wav2vec) to obtain a hidden variable Z, then maps the hidden variable Z to a discretized hidden variable Z\hat{ } by introducing the quantization module (which does not exist in wav2vec), encodes a discretized hidden variable at a historical moment by using a context network (the same as wav2vec), to obtain a context feature vector C, and then replaces an acoustic feature (log-mel filterbanks) with a semantic feature generated by BERT to train a wav2letter ASR model in a supervised manner. The wav2vec 2.0 model learns a representation of audio by using a self-supervised learning method.

The wav2vec 2.0 model is a model which is proposed based on wav2vec and which incorporates the quantization module of vq-wav2vec and a transformer. An encoder network of this model is based on a CNN, and a context network of this model is based on the transformer. This model is configured to restore, at a feature level, frames quantized through masking.

In some embodiments, a base model and a distillation model of a to-be-trained phone recognition model each include the wav2vec 2.0 model.

During training of the base model of the to-be-trained phone recognition model, the first sample audio is inputted into the base model, and a model loss of the base model may be obtained based on a label of the first sample audio and a recognition result of the base model for the first sample audio.

Since the second sample audio is multi-user utterance audio, a label of the second sample audio needs to include a phone label corresponding to audio of at least one user and a voiceprint feature of the user. Therefore, during training of the distillation model of the to-be-trained phone recognition model, the distillation model may perform phone recognition on the second sample audio based on the voiceprint feature in the label of the second sample audio, to obtain a phone recognition result, so that a model loss of the distillation model may be obtained based on the phone recognition result and the phone label of the second sample audio.

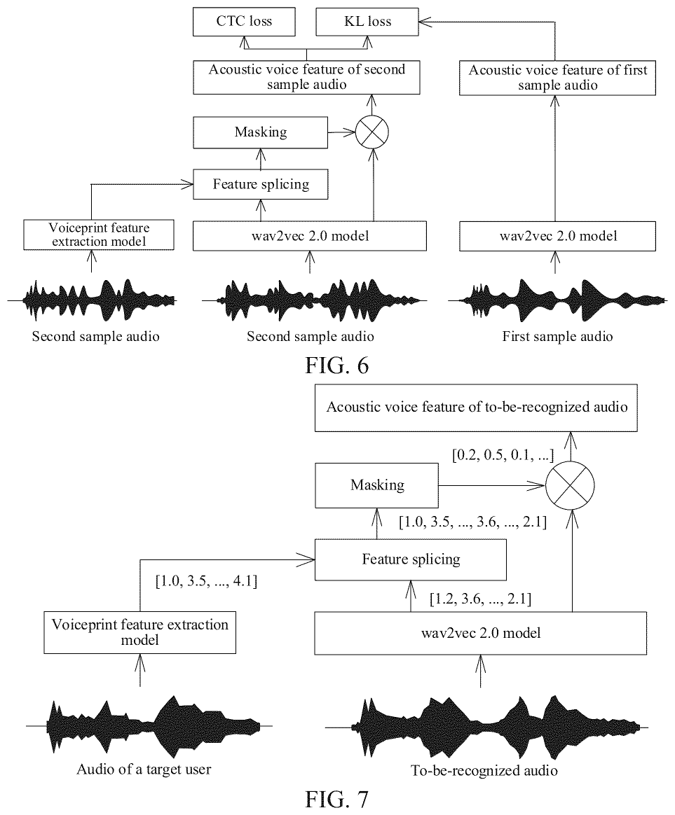

To illustrate as an example, referring to FIG. 6, when the base model and the distillation model each include the wav2vec 2.0 model, a process of calculating the model loss of the base model is as follows: For each first sample audio, discretization is performed on the first sample audio, to obtain a plurality of first sample audio frames (for example, T first sample audio frames) included in the first sample audio. A feature of each first sample audio frame is extracted. The phone recognition is performed on the feature of each first sample audio frame, to obtain a phone recognition probability tᵢ corresponding to each first sample audio frame, tᵢ=SoftMax(f_{teacher}(h_{clean}ⁱ)/T). SoftMax(f_{teacher}) is a classification function of the base model, and h_{clean}ⁱ is an acoustic voice feature of the first sample audio. The model loss l(tᵢ) (a first loss value) of the base model may be obtained based on a phone label and the phone recognition probability corresponding to each first sample audio frame.

The distillation model may perform the phone recognition on the second sample audio based on the voiceprint feature in the label of the second sample audio, to obtain the phone recognition result. A process specifically includes the following: A feature h_{speech}ⁱ of each frame of sample audio in the second sample audio is extracted. The voiceprint feature D in the label of the second sample audio is spliced with the feature h_{speech}ⁱ of each frame of sample audio, to obtain a spliced sample feature f[D, h_{speech}ⁱ] of each frame of sample audio. Nonlinear transformation is performed on the spliced sample feature of each frame of sample audio, to obtain a masked representation mᵢ of each frame of sample audio in the second sample audio, and mᵢ=σ(f([D, h_{speech}ⁱ])). For each frame of sample audio, the audio feature of the frame of sample audio is multiplied by the masked representation thereof, to obtain an acoustic voice feature h_{enhance}ⁱ of the sample audio frame, and h_{enhance}ⁱ=h_{speech}ⁱ×mᵢ. Then, a fully connected network transformation is performed on the acoustic voice feature of each frame of sample audio in the second sample audio for classification, to obtain a phone recognition probability sᵢ corresponding to each frame of sample audio in the second sample audio, and sᵢ=SoftMax(f_{student}(h_{enhance}ⁱ)), SoftMax(f_{student}) being a phone classification function of the distillation model. A model loss l(sᵢ) (a second loss value) of the distillation model can be obtained based on a phone label and a phone recognition probability corresponding to each frame of sample audio in the second sample audio.

In some embodiments, the voiceprint feature in the label of the second sample audio may be obtained through voiceprint feature extraction on the second sample audio by using a pre-trained voiceprint feature extraction model.

Operation S240: Respectively adjust a model parameter of the base model and a model parameter of the distillation model based on the first loss value and the second loss value, to obtain a trained phone recognition model.

The respectively adjusting a model parameter of the base model and a model parameter of the distillation model based on the first loss value and the second loss value may be adjusting the model parameter of the base model based on the first loss value, and adjusting the model parameter of the distillation model based on the second loss value; or obtaining a target loss value based on the first loss value and the second loss value, to respectively adjust the model parameter of the base model and the model parameter of the distillation model based on the target loss value. The obtaining a target loss value based on the first loss value and the second loss value may include performing weighted summation on the first loss value and the second loss value, to obtain the target loss value, or selecting a larger one of the first loss value and the second loss value. The above ways of obtaining the target loss value are merely examples, and other ways to obtain the target loss value are possible. Accordingly, the above described ways to obtain the target loss value are not construed as a limitation on the solution.

To enable the base model to transfer learned knowledge to the distillation model and enable the distillation model to perform the phone recognition more accurately, a relatively high correlation is required between the base model and the distillation model. In some embodiments of this application, operation S240 includes the following operations:

Operation S242: Perform weighted summation on the first loss value and the second loss value, to obtain a target loss value.

Specifically, the target loss value may be calculated by using a calculation equation L=λ×l(sᵢ)+(1−λ)×l(tᵢ), where L is the target loss value, λ is a weight coefficient of the first loss value, l(tᵢ) is the model loss of the base model (the first loss value), and l(sᵢ) is the model loss of the distillation model (the second loss value).

Operation S244: Respectively adjust the model parameter of the base model and the model parameter of the distillation model based the target loss value, so that the phone recognition model converges, to obtain the trained phone recognition model.

The adjustment of the phone recognition model based on the target loss value is intended to minimize the model loss, so that the phone recognition model gradually converges. When the model parameter adjustment reaches a preset quantity such as 5000 or 10000, it may be considered that the model converges. Alternatively, when the model loss gradually reaches a fixed value such as zero, or is less than a preset value such as 0.05 or 0.01, it may be considered that the model converges. In this way, the trained phone recognition model can be obtained.

Referring to FIG. 6 again, the target loss value may include a loss in a stage in which the phone recognition model performs acoustic voice feature extraction, and may further include a loss in a stage in which the phone recognition model performs feature classification. In other words, the target loss value may include a KL loss and a CTC loss.

Through the above model training, knowledge learned by a phone recognition network (the base model) based on clean audio can be distilled into a phone recognition network (the distillation model) based on noisy audio, so as to guide training of the distillation model by using the base mode. In this way, the trained base model and distillation model can accurately describe a correlation between a spectrum feature of audio and a phone.

The model training process described in operation S230 to operation S240 is merely an example, and is not construed as a limitation on this application. In some other embodiments, the model training process may alternatively include: training the base model by using the first sample audio to obtain a trained base model, and inputting the second sample audio into the trained base model and the distillation model to obtain a first output result of the trained base model and a second output result of the distillation model, after the first sample audio and the second sample audio are obtained; and obtaining a third loss value based on the first output result and the phone label of the second sample audio, obtaining a fourth loss value based on the second output result and the phone label of the second sample audio, and adjusting the model parameter of the distillation model based on the third loss value and the fourth loss value, to obtain the trained phone recognition model. The adjusting the model parameter of the distillation model based on the third loss value and the fourth loss value may specifically include performing the weighted summation on the third loss value and the fourth loss value, to obtain a target loss value, and adjusting the model parameter of the distillation model based on the target loss value, so that the phone recognition model converges, to obtain the trained phone recognition model.

Operation S250: Extract an audio feature of the to-be-recognized audio by using a trained distillation model.

During the extraction of the audio feature of the to-be-recognized audio, the extraction may be performed through only one feature extraction operation. For example, the feature extraction may be performed by using a convolution layer, or the extraction may be performed through a plurality of feature extraction operations. For example, the extraction may be performed through at least two feature extraction operations of preprocessing, convolution, and feature processing, as long as the audio feature of the to-be-recognized audio can be accurately extracted.

In some embodiments of this application, the extracting an audio feature of the to-be-recognized audio includes the following operations:

Operation S252: Input the to-be-recognized audio into a voice encoder included in the trained distillation model, and perform discrete quantization on the to-be-recognized audio by using a shallow feature extraction layer of the voice encoder, to obtain a plurality of frames of voices included in the to-be-recognized audio.

Operation S254: Extract an audio feature corresponding to each frame of voice in the to-be-recognized audio by using a deep feature extraction layer of the voice encoder.

The shallow feature extraction layer may specifically be composed of a plurality of layers of CNNs and quantizers, and is configured to perform the discrete quantization on the to-be-recognized audio, to obtain the plurality of frames of voices included in the to-be-recognized audio. The deep feature extraction layer may specifically be composed of a plurality of transformers or a CNN, or may be composed of a CNN, and is configured to extract an audio feature corresponding to each frame of voice.

Referring to FIG. 7, when the trained distillation model includes the wav2vec 2.0 model, the above extraction process includes: inputting the to-be-recognized audio into the voice encoder included in the trained distillation model, and performing the discrete quantization on the to-be-recognized audio by using the plurality of layers of CNNs and quantizers of the voice encoder, to obtain the plurality of frames of voices included in the to-be-recognized audio; and successively extracting the audio feature corresponding to each frame of voice by using the plurality of transformers of the voice encoder.

Operation S260: Perform denoising on the audio feature of the to-be-recognized audio by using the trained distillation model based on the reference voiceprint feature, to obtain an acoustic voice feature of a target user.

For a process of performing the denoising on the audio feature of the to-be-recognized audio based on the reference voiceprint feature, reference may be made to the above specific description of the plurality of denoising manners in operation S124.

Referring to FIG. 7, to improve accuracy of phone recognition on audio of a user in audio of a plurality of users, in some embodiments, the performing denoising on the audio feature of the to-be-recognized audio based on the reference voiceprint feature may specifically include the following operations:

Operation S262: Splice the reference voiceprint feature and the audio feature of the to-be-recognized audio, to obtain a spliced feature.

Operation S264: Perform nonlinear transformation on the spliced feature, to obtain a masked representation of the to-be-recognized audio.

Operation S266: Multiply the masked representation of the to-be-recognized audio by the audio feature of the to-be-recognized audio, to obtain the acoustic voice feature of the target user.

Content in square brackets in FIG. 7 is specifically the audio feature, the reference voiceprint feature, the spliced feature, and the masked representation of the to-be-recognized audio represented in a form of a feature vector, and is merely an example.

The specific details previously described for performing operation S122 to operation S126 may be similarly applicable for performing operation S262 to operation S266, and so are not repeated here.

The performing nonlinear transformation on the spliced feature may be performing the nonlinear transformation on the spliced feature by using a nonlinear transformation calculation equation, or performing the nonlinear transformation on the spliced feature by using an activation function in the trained phone recognition model.

For example, if the nonlinear transformation is performed by using the activation function, an activation function such as a Sigmoid function, a Tanh function, or a ReLU function may be used, which is not specifically limited in this embodiment.

The multiplying the masked representation of the to-be-recognized audio by the audio feature of the to-be-recognized audio, to obtain the acoustic voice feature of the to-be-recognized audio can achieve explicit learning of a masked representation of a target speaker in a model framework, to shield impact of another speaker. In other words, the obtained acoustic voice feature of the to-be-recognized audio includes only the audio feature of the target user.

Operation S270: Perform phone recognition on the acoustic voice feature by using the trained distillation model, to obtain a phone recognition result corresponding to the target user.

Operation S270 may specifically include: performing classification calculation on the acoustic voice feature by using a classifier or a classification function in an output layer of the trained distillation model, to obtain probabilities that the acoustic voice feature is classified as each phone; and obtaining the phone recognition result corresponding to the acoustic voice feature based on the probabilities that the acoustic voice feature is classified as each phone. Specifically, a phone corresponding to a highest probability may be used as the phone recognition result corresponding to the acoustic voice feature.

The specific details previously described for performing operation S126 may be similarly applicable for the classifier or performing the classification function in the output layer of the trained distillation model, and so are not repeated here.

According to the above method of this application, the base model and the distillation model of the to-be-trained phone recognition model may be trained by using the first sample audio uttered by the single person and the second sample audio uttered by the plurality of persons, so that during subsequent recognition on the to-be-recognized audio by using the trained phone recognition model, not only a phone corresponding to the single-person utterance audio but also phones of audio corresponding to one or more speakers when a plurality of persons speak (for example, the phone of the audio corresponding to the target user to which the reference voiceprint belongs) may be recognized merely by deploying the distillation model online. Since the distillation model has a low data dimension, a structure of the distillation model is relatively simple, so that a memory space occupied for the online deployment can be effectively reduced, and efficiency of the model can be effectively improved. In addition, subsequently, the phone recognition result corresponding to the target speaker to which the reference voiceprint belongs can be accurately recognized from the audio of the plurality of speakers by using the trained phone recognition model based on the reference voiceprint feature, which eliminates voice interference from a person other than the target speaker, thereby effectively improving accuracy of the phone recognition result.

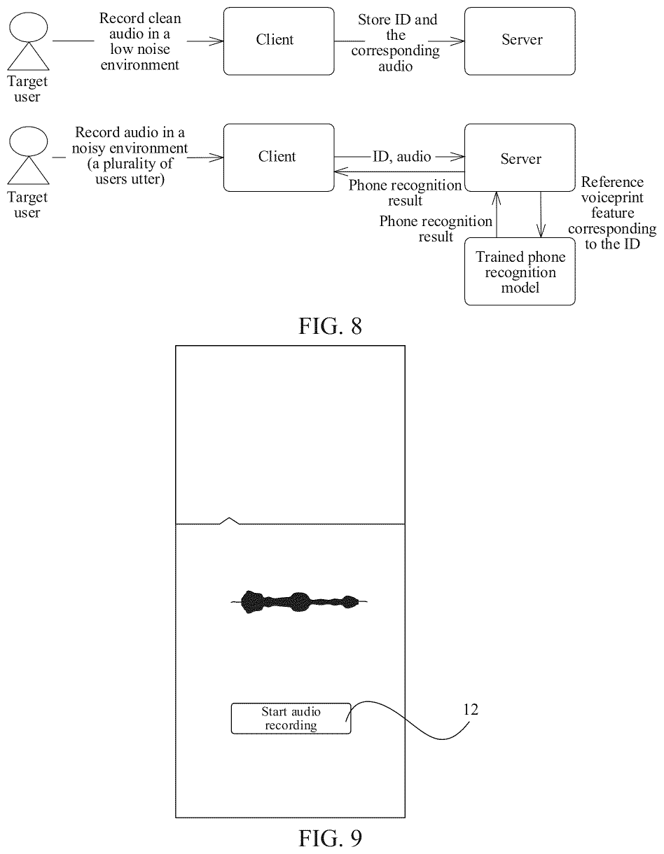

Referring to FIG. 8 to FIG. 11, an embodiment of this application provides a phone recognition method. The method is applicable to an electronic device equipped with a device control client that can perform voice control through voice and a server deployed with a phone recognition model, or is applicable to an electronic device including one or more of an instant messaging client, a content interaction client, an education client, a social network client, a shopping client, and an audio/video playback client that can perform voice input or voice interaction in a noisy environment and the server deployed with the phone recognition model. The phone recognition method is further applicable to an Internet of Vehicles system, so that an on-board terminal can control or use a client installed in the on-board terminal through voice input or voice interaction. Exemplarily, the phone recognition method is used in the device control client. The method specifically includes the following:

The server obtains single-user utterance audio in an environment with a noise intensity less than a first preset value as a first sample audio, and obtains multi-user utterance audio as second sample audio.

After obtaining the first sample audio and the second sample audio, the server may train a base model of a knowledge distillation model based on the first sample audio. During the training of the base model, for each piece of first sample audio, discretization is performed on the first sample audio by using a shallow feature extraction layer (a convolution layer) of a wav2vec 2.0 model, to obtain a plurality of first sample audio frames included in the first sample audio. Then, a feature of each first sample audio frame is extracted by using a deep feature extraction layer (a transformer layer) of the wav2vec 2.0 model. Then, phone recognition and classification are performed on the feature of each first sample audio frame by using a softmax classification function in an output layer of the wav2vec 2.0 model, to obtain a phone recognition result corresponding to each first sample audio frame. A probability that a result of the phone recognition on the first sample audio is correct may be obtained based on the result, so that a first loss value during the training of the base model may be obtained based on the probability that the result of the phone recognition on each piece of first sample audio is correct.

The server may further train a distillation model of the knowledge distillation model based on the second sample audio. Specifically, during the training of the distillation model, for each piece of second sample audio, the discretization is performed on the second sample audio by using the shallow feature extraction layer (the convolution layer) of the wav2vec 2.0 model, to obtain a plurality of second sample audio frames included in the second sample audio. Then, a feature of each second sample audio frame is extracted by using the deep feature extraction layer (the transformer layer) of the wav2vec 2.0 model. Then, a voiceprint feature in a label of the second sample audio is spliced with the feature of each frame of sample audio, to obtain a spliced sample feature of each frame of sample audio. Nonlinear transformation is performed on the spliced sample feature of each frame of sample audio, to obtain a masked representation of each frame of sample audio in the second sample audio. For each frame of sample audio, the audio feature of the frame of sample audio is multiplied by the masked representation thereof, to obtain an acoustic voice feature of the sample audio frame. Then, fully connected network transformation is performed on the acoustic voice feature of each frame of sample audio in the second sample audio, and classification is performed by using the softmax classification function in the output layer of the wav2vec 2.0 model, to obtain a phone recognition result corresponding to each frame of sample audio in the second sample audio. Finally, a model loss of the distillation model, i.e., a second loss value during the training of the distillation model, can be obtained based on the phone recognition result and a phone label corresponding to each frame of sample audio in the second sample audio.

After obtaining the first loss value during the training of the base model and the second loss value during the training of the distillation model, the server may perform weighted summation on the first loss value and the second loss value, to obtain a target loss value, and adjust model parameters of the base model and the distillation model based on the target loss value, so that the phone recognition model converges, to obtain a trained phone recognition model.

A data dimension of the base model in the knowledge distillation model is greater than a data dimension of the distillation model. In addition, the base model and the distillation model each include the wav2vec 2.0 model.

After the trained phone recognition model is obtained, device control, text input through voice, and voice search based on the above-described phone recognition method can be achieved through the phone recognition model.

Specifically, to enable a user to perform voice control using the device control client supporting device control through voice, for example, to perform a device control operation such as turning on a television, opening a curtain, or starting a robotic vacuum cleaner through voice, during the voice control by using the phone recognition model, the distillation model of the above-described trained phone recognition model may be specifically deployed online. That is, the trained phone recognition model may be deployed in the server, and the following operations may be performed by using a client in the electronic device, to achieve the device control operations. The client of the electronic device specifically performs the following operations:
generating, in response to a voiceprint capturing operation performed by the user, a prompt interface configured to prompt the target user to record a voice in a noisy environment with a noise intensity lower than a second preset value; starting audio recording in response to a touch operation performed by the target user on a control on a touch prompt interface, to obtain audio of the target user; and transmitting the audio of the target user to the server, so that the server performs voiceprint feature recognition on the audio of the target user by using a voiceprint recognition model deployed therein, to obtain a reference voiceprint feature.

Specifically, referring to FIG. 3 and FIG. 8 again, the prompt interface for voice recording includes a control configured to prompt the target user to record a voice. Prompt information “Capture a clean audio recording” is displayed in the control, to prompt the target user to record audio through the client in the noisy environment with the noise intensity lower than the second preset value. The client may transmit an ID of the target user and the corresponding audio to the server, so that the server can recognize the audio of the target user by using the voiceprint recognition model, to obtain a voiceprint feature of the target user, and store the voiceprint feature and the corresponding ID in an associate manner.

The above voiceprint recognition model may be arranged in the knowledge distillation model. In other words, the trained phone recognition model includes the base model, the distillation model, and the voiceprint recognition model. The reference voiceprint feature recognized by the voiceprint recognition model may serve as an input of the distillation model.

When the target user needs to perform voice control (for example, turning on a television) through the device control client, the target user may record to-be-recognized audio through the device control client and transmit the to-be-recognized audio to the server.

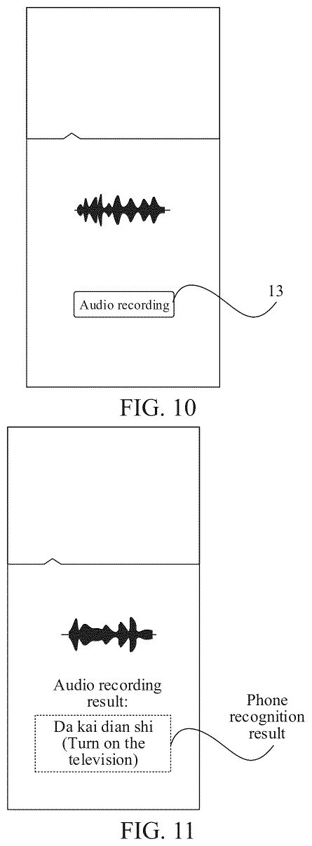

A specific audio recording process may be as follows: The target user may enable the device control client. The device control client may display a display interface shown in FIG. 9 after being enabled. The display interface has a first control 12 configured to prompt the user to record a voice, for example, a first control 12 configured with prompt information “Start audio recording”. The user may touch the first control 12, so that the electronic device starts voice recording. After the user touches the first control 12, the device control client can jump to display an interface showing that the electronic device is performing voice recording shown in FIG. 10. The interface has a second control 13. The second control 13 has prompt information prompting that the electronic device is performing audio recording. For example, the second control is configured with prompt information “Audio recording”. After voice information recording of the user is completed, the user may touch the second control 13, so that the electronic device stops the recording, thereby completing the recording of the to-be-recognized audio. After the recording of the to-be-recognized audio is completed, the to-be-recognized audio is transmitted to the server.

During the recording of the to-be-recognized audio, the user may be in a quiet environment, or may be in an environment with a plurality of speakers or in a noisy environment. To achieve accurate phone recognition on the to-be-recognized audio to perform the device control based on the phone recognition result, a process in which the server performs the phone recognition on the to-be-recognized audio by using the distillation model in the phone recognition model is as follows:

After receiving the to-be-recognized audio, the server inputs the to-be-recognized audio into a voice encoder included in a trained distillation model, and performs discrete quantization on the to-be-recognized audio by using a shallow feature extraction layer of the voice encoder, to obtain a plurality of frames of voices included in the to-be-recognized audio; extracts an audio feature corresponding to each frame of voice in the to-be-recognized audio by using a deep feature extraction layer of the voice encoder, and splices the reference voiceprint feature and the audio feature, to obtain a spliced feature; performs nonlinear transformation on the spliced feature by using an activation function in the trained phone recognition model, to obtain a masked representation of the to-be-recognized audio; multiplies the masked representation of the to-be-recognized audio by the audio feature of the to-be-recognized audio, to obtain the acoustic voice feature of the target user; calculates probabilities that the acoustic voice feature is classified as each phone by using a classification function in an output layer of a trained distillation model; and determines the phone recognition result corresponding to the target user based on the probabilities.

After obtaining the phone recognition result corresponding to the to-be-recognized audio, the server returns the corresponding phone recognition result to the device control client in the electronic device, and displays the phone recognition result obtained through the phone recognition on the to-be-recognized audio on the display interface of the device control client.

Exemplarily, when the to-be-recognized audio includes audio of a plurality of users, and the audio of the plurality of users includes audio “Turn on the television” uttered by the target user to which the reference voiceprint belongs, the phone recognition result obtained by using the distillation model through the phone recognition on the to-be-recognized audio based on the reference voiceprint needs to include a phone “Da kai dian shi”. Correspondingly, a voice recognition result “Turn on the television” may be obtained based on the above phone. In other words, the display interface of the device control client may display an interface including the phone recognition result and the voice recognition result, i.e., display the phone recognition result including “Da kai dian shi (Turn on the television)” shown in FIG. 11.

After the phone recognition result of the to-be-recognized audio is obtained by using the distillation model in the phone recognition model and the corresponding voice information is obtained based on the phone recognition result, it may be detected whether a control command corresponding to the voice information exists in the voice information, and a corresponding device is controlled to execute the control command based on the control command corresponding to the voice information when the control command corresponding to the voice information is detected.

For example, if the above obtained voice information is “Turn on the television” and the control command corresponding to the voice information is enabling the television, a television associated with the device control client may be controlled to be enabled.

The above application scenario of the phone recognition model is merely an example, and more application scenarios may be provided. For example, a scenario in which a target user performs speech-to-text through voice by using an instant messaging client when a plurality of users speak, and a scenario in which a target user performs content search, educational information search, social content search, item search, and audio/video search by using through a content interaction client, an education client, a social network client, a shopping client, or an audio/video playback client through speech-to-text through voice when a plurality of users speak may be provided.

The scenario in which a target user performs speech-to-text through voice by using an instant messaging client when a plurality of users speak is used as an example. If an existing method of performing a speech-to-text operation through voice by using an instant messaging client is adopted, in a scenario with a plurality of users, text information corresponding to a voice of the target user cannot be accurately recorded. Through the phone recognition method of this application, speech-to-text through voice of the target user can be accurately achieved in the scenario with a plurality of speakers.

A description is provided by using an example in which verification is performed on a model effect by using a public TIMIT dataset in the solution. The TIMIT dataset includes massive audio, and the audio is single-user utterance audio captured when a noise intensity is less than a first preset threshold. Data construction of multi-user utterance audio is first performed based on the dataset. Single-user utterance audio is randomly selected, and then clipped into audio clips of a same size. The audio clips are superposed to construct multi-user utterance audio. The single multi-user utterance audio and the multi-user utterance audio are used as a training dataset and testing dataset, respectively. In addition, 1000 pieces of real multi-user utterance audio are captured, to perform verification on effectiveness of the model. The phone recognition model (a proposed ASR) used in this application is compared with two base models. One of the two base models is a phone recognition model (a clean ASR) trained based on first sample audio which is single-user utterance audio when a noise intensity is less than a first preset threshold, and the other of the two base models is a phone recognition model (a noisy ASR) trained based on multi-user utterance audio. Performance (an error percentage of a recognition result) for the constructed noisy audio, the clean audio, and the captured noisy audio of speakers is compared. Comparison results are as shown in the following Table I.

TABLE I

| | Multi-speaker | Single-user | Real multi-user |
|---|---|---|---|
| Model | audio | utterance audio | utterance audio |
| Clean ASR | 89.1 | 12.6 | 65.1 |
| Noisy ASR | 58.2 | 18.1 | 40.3 |
| Proposed ASR | 32.4 | 13.1 | 37.3 |

Table I shows performance of different models on different datasets. It may be learned that, the phone recognition model provided in the embodiments of this application has a lowest phone recognition error percentage in different scenarios and behaves best. Therefore, through the phone recognition model of the embodiments of this application, accuracy of phone recognition can be ensured in scenarios in which different quantities of users speak.

Apparatus embodiments in this application and the above method embodiments correspond to each other. For specific principles in the apparatus embodiments, reference may be made to the content of the above method embodiments, which are not described in detail herein.

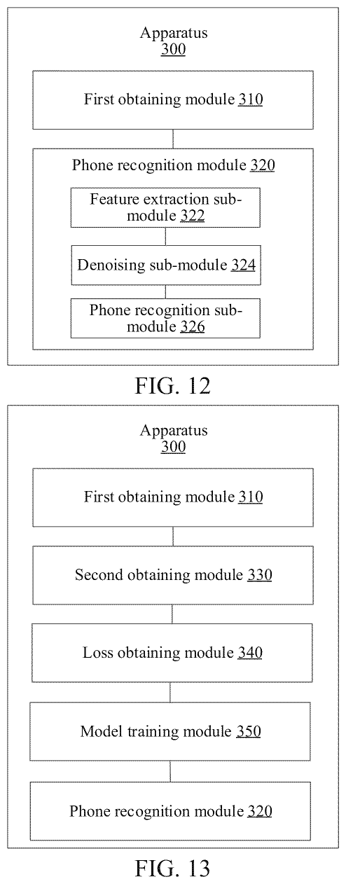

FIG. 12 shows a phone recognition apparatus 300 according to some embodiments. As shown in FIG. 12, the phone recognition apparatus 300 includes a first obtaining module 310 and a phone recognition module 320.

The first obtaining module 310 is configured to obtain a reference voiceprint feature and to-be-recognized audio.

The phone recognition module 320 is configured to input the to-be-recognized audio into a trained phone recognition model to perform phone recognition, to obtain a phone recognition result, the trained phone recognition model being obtained through training based on first sample audio and second sample audio, the first sample audio single-user utterance audio, and the second sample audio being multi-user utterance audio.

The phone recognition module 320 includes a feature extraction sub-module 322, a denoising sub-module 324, and a phone recognition sub-module 326. The feature extraction sub-module 322 is configured to extract an audio feature of the to-be-recognized audio. The denoising sub-module 324 is configured to perform denoising on the audio feature of the to-be-recognized audio based on the reference voiceprint feature, to obtain an acoustic voice feature of the target user. The phone recognition sub-module 326 is configured to perform the phone recognition on the acoustic voice feature, to obtain a phone recognition result corresponding to the target user.

Referring to FIG. 13, a phone recognition model includes a base model and a distillation model, a data dimension of the base model being greater than a data dimension of the distillation model. The apparatus 300 further includes a second obtaining module 330, a loss obtaining module 340, and a model training model 350.

The second obtaining module 330 is configured to obtain the first sample audio and the second sample audio.

The loss obtaining module 340 is configured to train the base model based on the first sample audio, to obtain a first loss value during the training of the base model, and train the distillation model based on the second sample audio, to obtain a second loss value during the training of the distillation model.

The model training model 350 is configured to respectively adjust a model parameter of the base model and a model parameter of the distillation model based on the first loss value and the second loss value, to obtain a trained phone recognition model.

In some embodiments, the model training model 350 includes a loss calculation sub-model and a model training sub-model. The loss calculation sub-model is configured to perform weighted summation on the first loss value and the second loss value, to obtain a target loss value. The model training sub-model is configured to respectively adjust the model parameter of the base model and the model parameter of the distillation model based the target loss value, so that the phone recognition model converges, to obtain the trained phone recognition model.

In some embodiments, the second obtaining module 330 is further configured to obtain single-user utterance audio in an environment with a noise intensity less than a first preset value as the first sample audio.

In some embodiments, the feature extraction sub-module 322 is further configured to: input the to-be-recognized audio into a voice encoder included in the trained distillation model, and perform discrete quantization on the to-be-recognized audio by using a shallow feature extraction layer of the voice encoder, to obtain a plurality of frames of voices included in the to-be-recognized audio; and extract an audio feature corresponding to each frame of voice in the to-be-recognized audio by using a deep feature extraction layer of the voice encoder.

In some embodiments, the denoising sub-module 324 includes a feature splicing unit, a nonlinear transformation unit, and a denoising unit. The feature splicing unit is configured to splice the reference voiceprint feature and the audio feature of the to-be-recognized audio, to obtain a spliced feature. The nonlinear transformation unit is configured to perform nonlinear transformation on the spliced feature, to obtain a masked representation of the to-be-recognized audio. The denoising unit is configured to multiply the masked representation of the to-be-recognized audio by the audio feature of the to-be-recognized audio, to obtain the acoustic voice feature of the target user.

The nonlinear transformation unit is further configured to perform the nonlinear transformation on the spliced feature by using a fully connected layer and an activation function in the trained phone recognition model, to obtain the masked representation of the to-be-recognized audio.

In some embodiments, the phone recognition sub-module 326 is further configured to: calculate probabilities that the acoustic voice feature of the target user is classified as each phone by using a classification function in an output layer of a trained distillation model; and determine the phone recognition result corresponding to the target user based on the probabilities that the acoustic voice feature of the target user is classified as each phone.

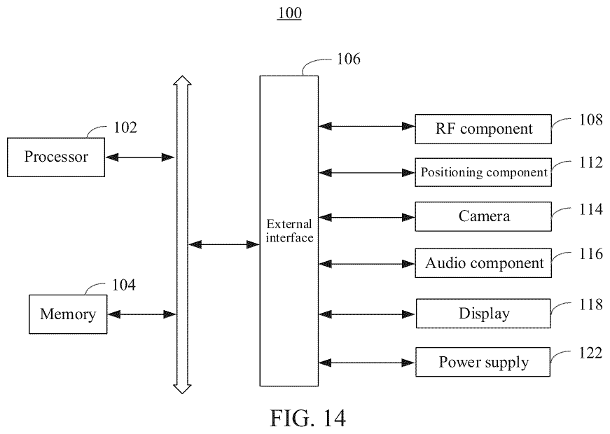

An electronic device provided in the embodiments of this application is described below with reference to FIG. 14.

Referring to FIG. 14, based on the phone recognition model method provided in the above embodiments, an embodiment of this application further provides another electronic device 100 including a processor 102 that can perform the above method. The electronic device 100 may be a server or a terminal device. The terminal device may be a device such as a smartphone, a tablet computer, a computer, or a portable computer.

The electronic device 100 further includes a memory 104. The memory 104 has stored therein a program that can perform the content in the above embodiments, and the processor 102 can execute the program stored in the memory 104.

The processor 102 may include one or more cores configured to process data and a message matrix unit. The processor 102 is connected to each part in the entire electronic device 100 by using various interfaces and lines, and executes various functions of the electronic device 100 and processes data by running or executing instructions, the program, a code set, or an instruction set stored in the memory 104 and calling data stored in the memory 104. In some embodiments, the processor 102 may be implemented by using at least one hardware form of a digital signal processor (DSP), a field-programmable gate array (FPGA), and a programmable logic array (PLA). The processor 102 may have one or a combination of a central processing unit (CPU), a graphics processing unit (GPU), a modem, and the like integrated therein. The CPU is mainly configured to process an operating system, a user interface (UI), an application program, and the like. The GPU is configured to render and draw displayed content. The modem is configured to process wireless communication. The modem may alternatively not be integrated in the processor 102, and is achieved through an independent communication chip.

The memory 104 may include a random access memory (RAM) or a read-only memory (ROM). The memory 104 may be configured to store the instructions, the program, code, the code set, and the instruction set. The memory 104 may include a program storage area or a data storage area. The program storage area may store instructions configured for implementing the operating system, instructions configured for implementing at least one function, instructions configured for implementing the following method embodiments, and the like. The data storage area may store data (for example, first sample audio, second sample audio, and a reference voiceprint feature) obtained during use of the electronic device 100.

The electronic device 100 may further include a network module and a screen. The network module is configured to receive and transmit an electromagnetic wave, to achieve conversion between the electromagnetic wave and an electrical signal, so as to communicate with a communication network or another device, for example, communicate with an audio playback device.

In some embodiments, the electronic device 100 may further include an external interface 106 and at least one peripheral device. The processor 102, the memory 104, and the external interface 106 may be connected through a bus or a signal line. Each peripheral device may be connected to the external interface through a bus, a signal line, or a circuit board. Specifically, the peripheral device includes at least one of a radio frequency (RF) component 108, a positioning component 112, a camera 114, an audio component 116, a display 118, and a power supply 122.

The external interface 106 may be configured to connect the at least one input/output (I/O)-related peripheral device to the processor 102 and the memory 104. In some embodiments, the processor 102, the memory 104, and the external interface 106 are integrated on the same chip or circuit board. In some other embodiments, any one or two of the processor 102, the memory 104, and the external interface 106 may be implemented on an independent chip or circuit board, which is not limited in this embodiment of this application. The RF component 108 is configured to receive and transmit an RF signal, which is also referred to as an electromagnetic signal. The RF component 108 communicates with the communication network and another communication device through the electromagnetic signal. The RF component 108 converts an electric signal into an electromagnetic signal for transmission, or converts a received electromagnetic signal into an electric signal. The positioning component 112 is configured to determine a current geographical location of the electronic device, to implement navigation or a location-based service (LBS). The camera 114 is configured to capture an image or a video. The audio component 116 may include a microphone and a speaker. The display 118 is configured to display the UI. The power supply 122 is configured to supply power to components in the electronic device 100.

An embodiment of this application further provides a computer-readable storage medium. The computer-readable storage medium has program code stored therein. The computer code may be called by a processor, to perform the method described in the above method embodiments.

The computer-readable storage medium may be an electronic memory such as a flash memory, an electrically erasable programmable read-only memory (EEPROM), an erasable programmable read-only memory (EPROM), a hard disk, or a ROM. In some embodiments, the computer-readable storage medium includes a non-transitory computer-readable storage medium. The computer-readable storage medium has a space for storing program code configured for performing any method operation in the above method. The program code may be read from or written into one or more computer program products. The program code may be, for example, compressed in an appropriate form.

An embodiment of this application further provides a computer program product or a computer program, the computer program product or the computer program including computer instructions, the computer instructions being stored in a computer-readable storage medium. A processor of a computer device reads the computer instructions from the computer-readable storage medium, and executes the computer instructions, so that the computer device performs the method described in the above optional implementations.

In summary, according to the phone recognition method, the electronic device, and the storage medium provided in this application, in the training stage of the phone recognition model, the base model and the distillation model of the phone recognition model may be trained by using the single-user audio (the first sample audio) and the multi-user audio (the second sample audio), so that during subsequent recognition on the to-be-recognized audio by using the trained phone recognition model, not only a phone corresponding to the single-person utterance audio but also phones of audio corresponding to one or more speakers when a plurality of persons speak (for example, the phone of the audio corresponding to the target user to which the reference voiceprint belongs) may be recognized merely by deploying the distillation model online. Since the distillation model has a low data dimension, a structure of the distillation model is relatively simple, so that a memory space occupied for the online deployment can be effectively reduced, and efficiency of the model can be effectively improved. In addition, subsequently, the phone recognition result corresponding to the target speaker to which the reference voiceprint belongs can be accurately recognized from the audio of the plurality of speakers by using the trained phone recognition model based on the reference voiceprint feature, which eliminates voice interference from a person other than the target speaker, thereby effectively improving accuracy of the phone recognition result.

Finally, the above embodiments are merely used for describing the technical solutions of this application, and are not intended to limit this application. Although this application is described in detail with reference to the above embodiments, a person skilled in the art understands that, modifications may still be made to the technical solutions described in the above embodiments, or equivalent replacements may be made to some of the technical features, and these modifications or replacements do not cause the essence of corresponding technical solutions to depart from the scope of the technical solutions in the embodiments of this application.

What is claimed is:

1. A phone recognition method, performed by a computer device, the method comprising:
obtaining a reference voiceprint feature of a target user and to-be-recognized audio;
inputting the to-be-recognized audio into a trained phone recognition model to perform phone recognition, to obtain a phone recognition result, the trained phone recognition model being obtained through training based on first sample audio and second sample audio, the first sample audio comprising single-user utterance audio, and the second sample audio comprising multi-user utterance audio;
extracting an audio feature of the to-be-recognized audio;
performing denoising on the audio feature of the to-be-recognized audio based on the reference voiceprint feature, to obtain an acoustic voice feature of the target user; and
performing the phone recognition on the acoustic voice feature, to obtain a phone recognition result corresponding to the target user.

2. The method according to claim 1, wherein the phone recognition model comprises a base model and a distillation model, a data dimension of the base model being greater than a data dimension of the distillation model, and the method further comprises:
obtaining the first sample audio and the second sample audio;
training the base model based on the first sample audio, to obtain a first loss value during the training of the base model, and training the distillation model based on the second sample audio, to obtain a second loss value during the training of the distillation model; and
respectively adjusting a model parameter of the base model and a model parameter of the distillation model based on the first loss value and the second loss value, to obtain the trained phone recognition model.

3. The method according to claim 2, wherein the respectively adjusting a model parameter of the base model and a model parameter of the distillation model based on the first loss value and the second loss value, to obtain the trained phone recognition model comprises:
determining a target loss value based on the first loss value and the second loss value;
respectively adjusting the model parameter of the base model and the model parameter of the distillation model based on the target loss value, so that the phone recognition model converges, to obtain the trained phone recognition model.

4. The method according to claim 3, wherein the determining a target loss value based on the first loss value and the second loss value comprises:
performing weighted summation on the first loss value and the second loss value, to obtain the target loss value; or
selecting a larger one of the first loss value and the second loss value as the target loss value.

5. The method according to claim 2, wherein the obtaining the first sample audio comprises:
obtaining single-user utterance audio in an environment with a noise intensity less than a first preset value as the first sample audio.

6. The method according to claim 2, wherein the extracting an audio feature of the to-be-recognized audio comprises:
inputting the to-be-recognized audio into a voice encoder comprised in a trained distillation model, and performing discrete quantization on the to-be-recognized audio by using a shallow feature extraction layer of the voice encoder, to obtain a plurality of frames of voices comprised in the to-be-recognized audio; and
extracting an audio feature corresponding to each frame of voice in the to-be-recognized audio by using a deep feature extraction layer of the voice encoder.

7. The method according to claim 2, wherein the performing the phone recognition on the acoustic voice feature, to obtain a phone recognition result corresponding to the target user comprises:
calculating probabilities that the acoustic voice feature is classified as each phone by using a classification function in an output layer of a trained distillation model; and
determining the phone recognition result corresponding to the target user based on the probabilities.

8. The method according to claim 1, wherein the phone recognition model comprises a base model and a distillation model, a data dimension of the base model being greater than a data dimension of the distillation model, and the method further comprises:
obtaining the first sample audio and the second sample audio;
training the base model by using the first sample audio, to obtain a trained base model;
inputting the second sample audio into the trained base model and the distillation model, to obtain a first output result of the trained base model and a second output result of the distillation model;
obtaining a third loss value based on the first output result and a phone label of the second sample audio, and obtaining a fourth loss value based on the second output result and the phone label of the second sample audio; and
adjusting a model parameter of the distillation model based on the third loss value and the fourth loss value, to obtain a trained distillation model.

9. The method according to claim 1, wherein the performing denoising on the audio feature of the to-be-recognized audio based on the reference voiceprint feature, to obtain an acoustic voice feature of the target user comprises:
performing masking on an audio feature in the audio feature of the to-be-recognized audio other than an audio feature of the target user by using the trained phone recognition model based on the reference voiceprint feature, to obtain the acoustic voice feature of the target user.

10. The method according to claim 9, wherein the performing masking on an audio feature in the audio feature of the to-be-recognized audio other than an audio feature of the target user by using the trained phone recognition model based on the reference voiceprint feature, to obtain the acoustic voice feature of the target user comprises:
splicing the reference voiceprint feature and the audio feature of the to-be-recognized audio, to obtain a spliced feature;
performing nonlinear transformation on the spliced feature, to obtain a masked representation of the to-be-recognized audio; and
multiplying the masked representation of the to-be-recognized audio by the audio feature of the to-be-recognized audio, to obtain the acoustic voice feature of the target user.

11. The method according to claim 10, wherein the performing nonlinear transformation on the spliced feature, to obtain a masked representation of the to-be-recognized audio comprises:
performing the nonlinear transformation on the spliced feature by using a fully connected layer and an activation function in the trained phone recognition model, to obtain the masked representation of the to-be-recognized audio.

12. The method according to claim 1, wherein the performing denoising on the audio feature of the to-be-recognized audio based on the reference voiceprint feature, to obtain an acoustic voice feature of the target user comprises:
encoding the audio feature of the to-be-recognized audio by using a multi-speaker encoder in the trained phone recognition model, to obtain audio features corresponding to different speakers; and
searching the audio features corresponding to the different speakers for an audio feature corresponding to the target user based on the reference voiceprint feature.

13. The method according to claim 1, wherein the obtaining a reference voiceprint feature comprises:
obtaining audio of the target user in an environment with a noise intensity less than a second preset value; and
performing voiceprint feature recognition on the audio of the target user, to obtain the reference voiceprint feature.

14. A phone recognition apparatus, comprising:
a memory storing a plurality of instructions; and
a processor configured to execute the plurality of instructions, wherein upon execution of the plurality of instructions, the processor is configured to:
obtain a reference voiceprint feature of a target user and to-be-recognized audio;
input the to-be-recognized audio into a trained phone recognition model to perform phone recognition, to obtain a phone recognition result, the trained phone recognition model being obtained through training based on first sample audio and second sample audio, the first sample audio comprising single-user utterance audio, and the second sample audio comprising multi-user utterance audio;
extract an audio feature of the to-be-recognized audio;
perform denoising on the audio feature of the to-be-recognized audio based on the reference voiceprint feature, to obtain an acoustic voice feature of the target user; and
perform the phone recognition on the acoustic voice feature, to obtain a phone recognition result corresponding to the target user.

15. The phone recognition apparatus according to claim 14, wherein the phone recognition model comprises a base model and a distillation model, a data dimension of the base model being greater than a data dimension of the distillation model, and wherein the processor, upon execution of the plurality of instructions, is further configured to:
obtain the first sample audio and the second sample audio;
train the base model based on the first sample audio, to obtain a first loss value during the training of the base model, and training the distillation model based on the second sample audio, to obtain a second loss value during the training of the distillation model; and
respectively adjust a model parameter of the base model and a model parameter of the distillation model based on the first loss value and the second loss value, to obtain the trained phone recognition model.

16. The phone recognition apparatus according to claim 14, wherein the phone recognition model comprises a base model and a distillation model, a data dimension of the base model being greater than a data dimension of the distillation model, and wherein the processor, upon execution of the plurality of instructions, is further configured to:
obtain the first sample audio and the second sample audio;
train the base model by using the first sample audio, to obtain a trained base model;
input the second sample audio into the trained base model and the distillation model, to obtain a first output result of the trained base model and a second output result of the distillation model;
obtain a third loss value based on the first output result and a phone label of the second sample audio, and obtain a fourth loss value based on the second output result and the phone label of the second sample audio; and
adjust a model parameter of the distillation model based on the third loss value and the fourth loss value, to obtain a trained distillation model.

17. The phone recognition apparatus according to claim 14, wherein in order to perform denoising on the audio feature of the to-be-recognized audio based on the reference voiceprint feature, to obtain the acoustic voice feature of the target user, the processor, upon execution of the plurality of instructions, is configured to:
perform masking on an audio feature in the audio feature of the to-be-recognized audio other than an audio feature of the target user by using the trained phone recognition model based on the reference voiceprint feature, to obtain the acoustic voice feature of the target user.

18. A non-transitory computer-readable storage medium storing a plurality of instructions executable by a processor, wherein upon being executed by the processor, the plurality of instructions is configured to cause the processor to:
obtain a reference voiceprint feature of a target user and to-be-recognized audio;
input the to-be-recognized audio into a trained phone recognition model to perform phone recognition, to obtain a phone recognition result, the trained phone recognition model being obtained through training based on first sample audio and second sample audio, the first sample audio comprising single-user utterance audio, and the second sample audio comprising multi-user utterance audio;
extract an audio feature of the to-be-recognized audio;
perform denoising on the audio feature of the to-be-recognized audio based on the reference voiceprint feature, to obtain an acoustic voice feature of the target user; and
perform the phone recognition on the acoustic voice feature, to obtain a phone recognition result corresponding to the target user.

19. The non-transitory computer-readable storage medium according to claim 18, wherein for the processor to perform denoising on the audio feature of the to-be-recognized audio based on the reference voiceprint feature, to obtain the acoustic voice feature of the target user, the plurality of instructions, upon being executed by the processor, is configured to cause the processor to:
encode the audio feature of the to-be-recognized audio by using a multi-speaker encoder in the trained phone recognition model, to obtain audio features corresponding to different speakers; and
search the audio features corresponding to the different speakers for an audio feature corresponding to the target user based on the reference voiceprint feature.

20. The non-transitory computer-readable storage medium according to claim 18, wherein for the processor to obtain the reference voiceprint feature, the plurality of instructions, upon being executed by the processor, is configured to cause the processor to:
obtain audio of the target user in an environment with a noise intensity less than a second preset value; and
perform voiceprint feature recognition on the audio of the target user, to obtain the reference voiceprint feature.
